(19) United States
(12) Patent Application Publication
(10) Pub. No.: US 2015/0215324 A1
(43) Pub. Date: Jul. 30, 2015

(54) MANAGING COMMUNICATIONS FOR A GROUP OF USERS

(71) Applicant: International Business Machines Corporation, Armonk, NY (US)

(72) Inventors: Jonathan F. Brunn, Logan, UT (US); Jessica W. Forrester, Raleigh, NC (US); Stephen C. Hess, Durham, NC (US); Jeffrey R. Hoy, Southern Pines, NC (US)

(73) Assignee: International Business Machines Corporation, Armonk, NY (US)

(21) Appl. No.: 14/168,918

(22) Filed: Jan. 30, 2014

(51) Int. Cl. H04L 29/06; H04L 29/08; H04W 12/08

(52) U.S. Cl. CPC H04L 63/104; H04W 12/08; H04L 67/22

(57) ABSTRACT

Managing communications for a group of users includes with a managing system registering at least two users to create a group of users allowed to establish communications within the group of users, associating at least one communication device to each user in the group of users to allow the communications to be exchanged within the group of users, and managing the communications for the group of users based on eligibility criteria.

### BACKGROUND

The present invention relates to managing communications, and more specifically to managing communications for a group of users.

Communication devices, such as mobile phones, are used to allow users to exchange communications with other users. The communications exchanged between the users, via the communication devices, include audio communications, video communications, text communications, or combinations thereof. The communication devices may include a display to display video communications and text communications to the users. Further, the communication devices may include an audio speaker and a microphone to allow the users to exchange audio communications.

### BRIEF SUMMARY

A method for managing communications for a group of users includes, with a managing system, registering at least two users to create a group of users allowed to establish communications within the group of users, associating at least one communication device to each user in the group of users to allow the communications to be exchanged within the group of users, and managing the communications for the group of users based on eligibility criteria.

A system for managing communications for a group of users includes, with a managing system, a registering engine to register at least two users to create a group of users allowed to establish communications within the group of users, an associating engine to associate at least one communication device to each user in the group of users to allow the communications to be exchanged within the group of users, a searching engine to search for users in the group of users and users not pertaining to the group of users, an inviting engine to invite other users not pertaining to the group of users to register with the group of users, a creating engine to create a virtual private network (VPN) in which the communications may be exchanged between the group of users, and a managing engine to manage the communications for the group of users based on eligibility criteria.

A computer program product includes a computer readable storage medium, the computer readable storage medium having computer readable program code embodied therewith. The computer readable program code having computer readable program code to, with a managing system, register at least two users to create a group of users allowed to establish communications within the group of users and manage the communications for the group of users based on eligibility criteria.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram of an example of a system for managing communications for a group of users, according to the principles described herein.

FIG. 2 is a diagram of an example of a managing system, according to the principles described herein.

FIG. 3 is a flowchart of an example of a method for managing communications for a group of users, according to one example of principles described herein.

FIG. 4 is a flowchart of an example of a method for managing communications for a group of users, according to one example of principles described herein.

FIG. 5 is a diagram of an example of a managing system, according to the principles described herein.

FIG. 6 is a diagram of an example of a managing system, according to the principles described herein.

Throughout the drawings, identical reference numbers designate similar, but not necessarily identical, elements.

### DETAILED DESCRIPTION

The present specification describes a method and a system for managing communications for a group of users, such that communications for the group of users are managed based on eligibility criteria.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As mentioned above, communication devices allow users to exchange communications. In some instances, communication devices can interfere with goals and productivity of the users. For example, a business may hold a retreat where employees of the business are to focus on goals associated with the business's next quarter. Communication devices may interrupt the focus of the employees on the retreat if communications are received from individuals not on the retreat. As a result, the goals associated with the business's next quarter may suffer due to the employees being interrupted by communications from individuals not on the retreat.

To eliminate the employees from being interrupted by communications from individuals not on the retreat, the employees may disable all communication devices. However, disabling all communication devices may be undesirable. For example, an employee may want to share information related to goals for the business's next quarter with other employees on the retreat. Further, the employee may want to share this information through communication devices. However, since all of the employees have disabled all communication devices, sharing the information related to goals for the business's next quarter via their communication devices is impossible.

The principles described herein include a method for managing communications for a group of users. Such a method includes, with a managing system, registering at least two users to create a group of users allowed to establish communications within the group of users, associating at least one communication device to each user in the group of users to allow the communications to be exchanged within the group of users, and managing the communications for the group of users based on eligibility criteria. Such a method allows communications to be limited to users within the group of users. As a result, the group of users may be able to avoid interruptions and distractions of communication being exchanged between the group of users and users not pertaining to the group of users.

In the specification and appended claims, the term “communication” is meant to be understood broadly as information that is exchanged between at least two communication devices. In one example, a communication may include an audio communication, a video communication, a text communication, or combinations thereof. For example, a communication such as an audio communication may exchange audio information between one communication device and another communication device.

In the specification and appended claims, the term “communication device” is meant to be understood broadly as a device used to exchange communications with another device. In one example, a communication device may include a tablet, a smart phone, a desktop, a laptop, other communication devices, or combinations thereof. Further, a communication device may allow a user to establish communications, such as audio communications, video communications, text communications, or combinations thereof, with another user.

In the specification and appended claims, the term “group of users” is meant to be understood broadly as at least two users allowed to establish communication with each other. In one example, users may register, with a managing system, to create the group of users. Once the users have registered to create the group of users, the users may exchange communication with each other via their communication devices.

In the specification and appended claims, the term “eligibility criteria” is meant to be understood broadly as rules that determine if a user can register with the group of users, remain registered to the group of users, can be invited to register with the group of users, or combinations thereof. In one example, the eligibility criteria may be determined by a group of users.

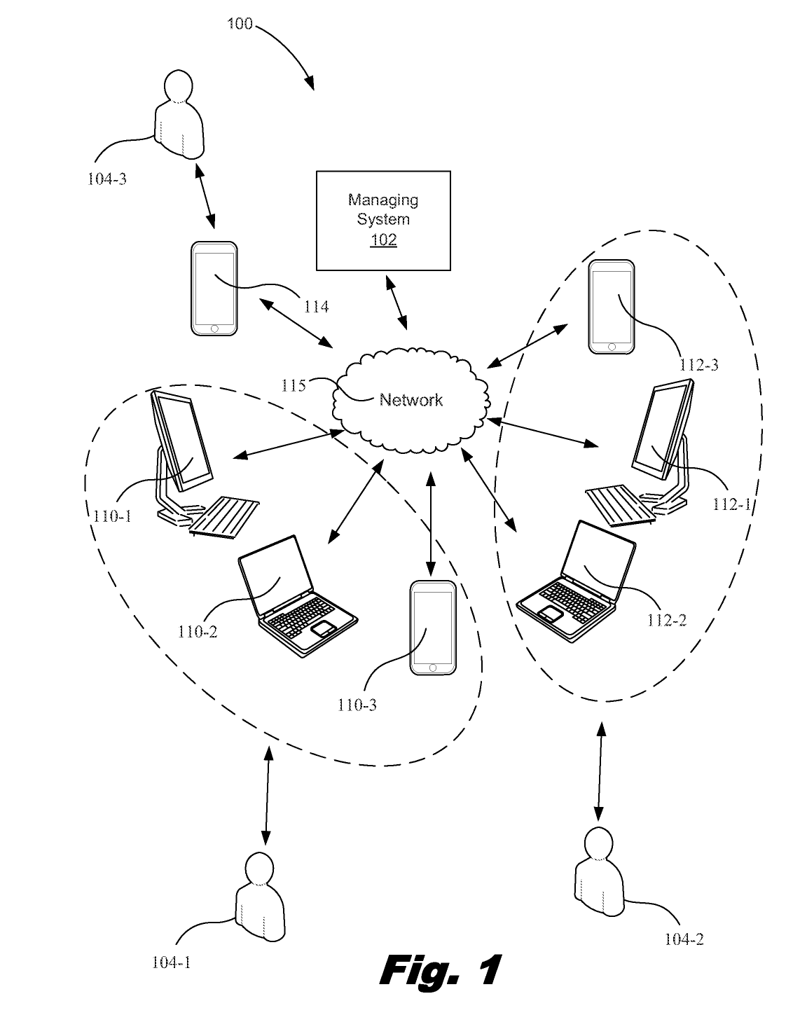

Referring now to the figures, FIG. 1 is a diagram of an example of a system (100) for managing communications for a group of users, according to the principles described herein. As will be described below, a managing system is in communication with a network to register at least two users to create a group of users allowed to establish communications within the group of users. Further, the managing system manages the communications for the group of users based on eligibility criteria.

As illustrated in FIG. 1, the system (100) includes a number of users (104). In this example, a first user (104-1), a second user (104-2), and a third user (104-3). Further, each of the users (104) has access to a number of communication devices (110, 112, 114). For example, the first user (104-1) has access to a desktop computer (110-1), a laptop computer (110-2), and a mobile phone (110-3). The second user (104-2) has access to a desktop computer (112-1), a laptop computer (112-2), and a mobile phone (112-3). The third user (104-3) has access to a mobile phone (114).

Further, the communication devices (110, 112, 114) allows the users (104) to exchange communications with each other. For example the mobile phone (110-3) allows the first user (104-1) to exchange communications with the second user (104-2) by accessing a network (115), such as a mobile network. The communications between the first user (104-1) and the second user (104-2) may be audio communications such as phone calls, video communications such as video conference calling, text communications such as short message service (SMS), or combinations thereof.

As illustrated, the system (100) includes a managing system (102). In one example, the managing system (102) registers at least two users to create a group of users allowed to establish communications within the group of users. For example, the first user (104-1) and the second user (104-2) may register, with the managing system (102), to create a group of users. As a result, the first user (104-2) and the second user (104-2) are allowed to establish communications with each other. As will be described below, since the third user (104-3) has not registered with the managing system (102), the third user may not establish communications with the first user (104-1) or the second user (104-2).

The managing system (102) further associates at least one communication device to each user in the group of users to allow the communication to be exchanged within the group of users. For example, the managing system (102) may associate the desktop computer (110-1), the laptop (110-2), and the mobile phone (110-3) to the first user (104-1). The managing system (102) may associate the desktop computer (112-1), the laptop (112-2), and the mobile phone (112-3) to the second user (104-2). As a result, the first user (104-1) and the second user (104-2) may establish communication through these communication devices (110, 112).

The managing system (102) further manages the communications for the group of users based on eligibility criteria. For example, the managing system (102) allows communications to be exchanged between the group of users. In this example, the first user (104-1) and the second user (104-2). In keeping with the given example, the managing system (102) prevents communications from being exchanged between the group of users and a user not pertaining to the group of users. In this example, the third user (104-3) may not exchange communications with the first user (104-1) or the second user (104-2). Such a managing system (102) allows communications to be limited to within the group of users. As a result, the group of users may be able to avoid interruptions and distractions of communication being exchanged between the group of users and a user not pertaining to the group of users. More information about the managing system (102) will be described in later parts of this specification.

While this example has been described with reference to the managing system being located over the network, the managing system may be located in any appropriate location according to the principles described herein. For example, the managing system may be located in a communication device, a server, a database, other locations, or combinations thereof.

While this example has been described with reference to creating one group of users, several groups of users may be created. For example, ten groups of users may be created.

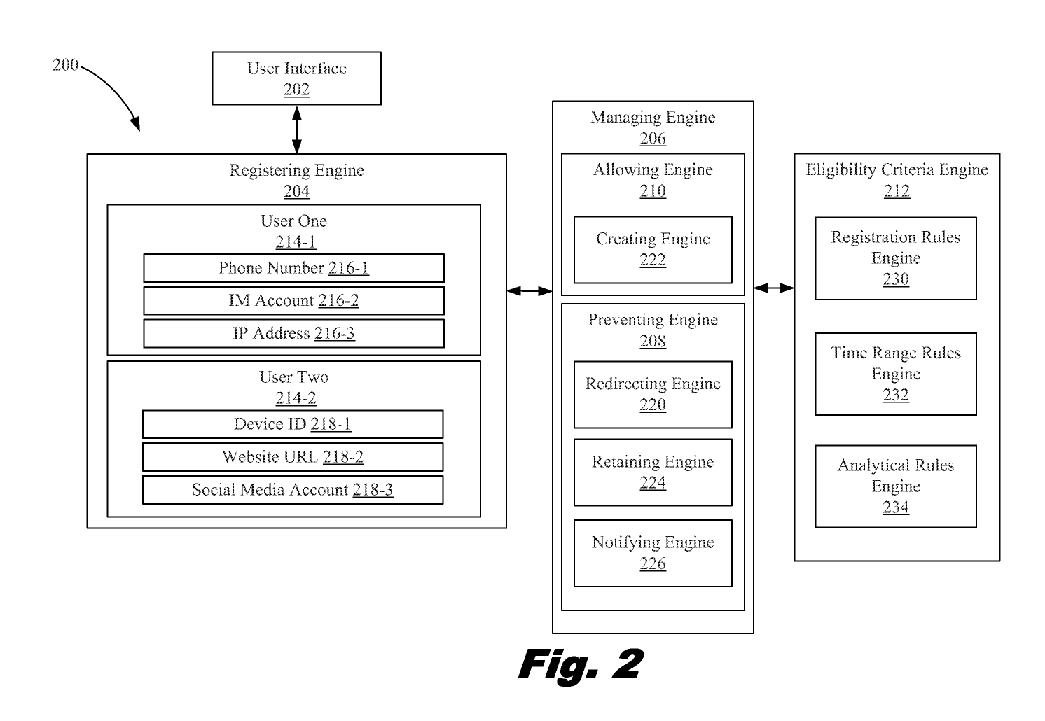

FIG. 2 is a diagram of an example of a managing system, according to the principles described herein. As mentioned above, managing system (200) manages the communications for a group of users based on eligibility criteria such that the managing system allows communications to be limited to within the group of users. As a result, the group of users may be able to avoid interruptions and distractions of communications being exchanged between the group of users and users not pertaining to the group of users.

As illustrated, the managing system (200) includes a user interface (202). In one example, the user interface (202) is displayed to a number of users when accessing the managing system (200). The user interface (202) allows the number of users to register with a group of users or to be removed from a group of users.

In some examples, the user interface (202) further allows a user to search for other users. To search for other users, a user may enter information associated with other users via the user interface (202). For example, a user may enter the other user's name, phone number, email address, other information, or combinations thereof. Further, the user interface (202) allows a user to invite other users to register with group of users.

As illustrated, the managing system (200) includes a registering engine (204). The registering engine (204) registers at least two users to create a group of users allowed to establish communications within the group of users. For example, the registering engine (204) registers user one (214-1) and user two (214-2). In this example, the registering engine (204) allows user one (214-1) to register a phone number (216-1), instant messaging (IM) account (216-2), and an internet protocol (IP) address (216-3). In keeping with this given example, the registering engine (204) allows user two (214-2) to register a device ID (218-1), a website uniform resource locator (URL) (218-2), and a social media account (218-3). In this example, once the users (214) have been registered to the group of users, the users (214) may establish communications via communication devices. Further, the registering engine (204) is in communication with a managing engine (206).

As illustrated in FIG. 2, the managing system (200) includes a managing engine (206). The managing engine (206) manages communications for the group of users based on eligibility criteria. In this example, the managing engine (206) includes an allowing engine (210). The allowing engine (210) allows communications to be exchanged between the group of users. In this example, the group of users include user one (214-1) and user two (214-2) that have registered via the registering engine (204). As illustrated, the allowing engine (210) includes a creating engine (222). In some example, the creating engine (222) is used to create a virtual private network (VPN). The VPN allows the group of users to exchange communications.

While this example has been described with reference to the creating engine (222) creating a VPN to allow the group of users to exchange communications, other methods may be used to allow the group of users to exchange communications. For example, the managing system (200) may integrate existing communication capabilities for managing the communications for the group of users. In one example, emails may be managed by an email server to allow the group of users to exchange email related communications. In another example, instant messaging may be managed by an instant message server to allow the group of users to exchange instant message related communications. In yet another example, a mobile phone may be managed by systems that are integrated into a mobile phone network to allow the group of users to exchange mobile phone related communications.

Further, in some examples, creating a VPN may be more advantageous than integrating existing communication capabilities for managing the communications for the group of users. As a result, the managing system (200) creates a VPN for managing the communications for the group of users. In other examples, integrating existing communication capabilities for managing the communications for the group of users may be more advantageous than creating a VPN. As a result, the managing system (200) integrates existing communication capabilities for managing the communications for the group of users.

The managing engine (206) further includes a preventing engine (208). The preventing engine (208) prevents communications from being exchanged between the group of users and a user not pertaining to the group of users. For example, user one (214-1) and user two (214-2) may exchange communication, but all other users not registered via the registering engine (204) are prevented from exchanging communication with user one (214-1) or user two (214-2).

In another example, the preventing engine (208) prevents communication through non-networked communication devices. For example, the managing system (200) may manage email and instant messaging for a group of users. In this example, the preventing engine (208) prevents all other communication devices from exchanging communications. For example, a user in the group of users is exchanging audio communications, during a meeting, via the user's mobile device. Further, the managing system (200) is not set up for mobile devices. As a result, the other users in the group of users may notify the managing system (200) to manage mobile devices such that all mobile devices are prevented from exchanging communications. Alternatively, the users in the group of users may invite the user to leave the group of users if the user continues to user the mobile device.

As illustrated, the preventing engine (208) includes a redirecting engine (220). The redirecting engine (220) redirects communications from being received by a user registered to the group of users from users not pertaining to the group of users. The redirecting engine (220) prevents the communication from reaching the intended user in the group of users by diverting the communication to an alternate destination. In some examples, this destination may be a server, a module on a user's communication device, a forwarding email account or phone number, other destinations, or a combination thereof.

As illustrated, the preventing engine (208) includes a retaining engine (224). The retaining engine (224) retains the communication sent by the user not pertaining to the group of users. In some examples, the retaining engine (224) may block or delay the communication until a specific amount of time has passed since the communication was sent, until the user registers with the group of users, or combinations thereof.

As illustrated, the managing engine (206) includes a notifying engine (226). The notifying engine (226) notifies at least one user not pertaining to the group of users that sent the communication that the user in the group of users is unable to receive the communications. In one example, the user not pertaining to the group of users that sent the communication may be notified by an audio communication, a video communication, a text communication, or combinations thereof.

As mentioned above, the managing engine (206) manages communications for the group of users based on eligibility criteria. As illustrated, the managing system (200) includes an eligibility criteria engine (212). The eligibility criteria engine (212) is in communication with the managing engine (206). In one example, the eligibility criteria engine (212) includes a registration rules engine (230). As will be described in other parts of this specification, the registration rules engine (230) defines how at least one communication device is to be associated to each user in the group of users.

Further, the eligibility criteria engine (212) includes a time range rules engine (232). As will be described in other parts of this specification, the time range rules engine (232) define a range of time for each user in the group of users to establish communications within the group of users.

Further, the eligibility criteria engine (212) includes an analytical rules engine (234). As will be described in other parts of this specification, the analytical rules engine (234) defines at least one characteristic of a user that is allowed to register with the group of users, invited to register with the group of users, or combinations thereof.

An overall example of the managing system (200) will now be described with reference to FIG. 2. In one example, a business may hold a retreat where employees of the business are to focus on goals associated with the business's next quarter. In this example, an employee named Kate may be on the retreat. Further, Kate's phone number is registered to her via the registering engine (204). Further, Kate is registered to a group of users on the retreat. Kate's manager, Rick, is not at the retreat. As a result, Rick has not registered to the group of users. In one example, if Rick calls Kate's phone, Rick's message may be managed by the managing engine (206). The managing engine (206) may utilize the preventing engine (208), as described above, to prevent Rick from establishing communications with Kate based on the eligibility criteria of the eligibility criteria engine (212). In this example, the notifying engine (226) notifies Rick that Kate is on a retreat and that she is unavailable to receive his call.

Further, if Rick desires to send communications to Kate, Rick may register with the group of users that Kate has registered to, if allowed to do so. For example, Rick may register with the group of users using the user interface (202). In this example, the registering engine (204) registers Rick's phone number to him. Further, the registering engine (204) registers Rick with the group that Kate is registered with. If Rick calls Kate again, the managing engine (206) manages the communication. The allowing engine (210) allows Rick to establish communication with Kate based on the eligibility criteria of the eligibility criteria engine (212).

In keeping with the example above, Jill is on the retreat. Jill is registered to the group through the user interface (202). Jill's IM account is registered to her by the registering engine (204). Jill attempts to send an instant message to her friend Jack who is not in the group of users. The managing engine (206) may utilize the preventing engine (208), as described above, to prevent Jill from establishing communications with Jack based on the eligibility criteria of the eligibility criteria engine (212).

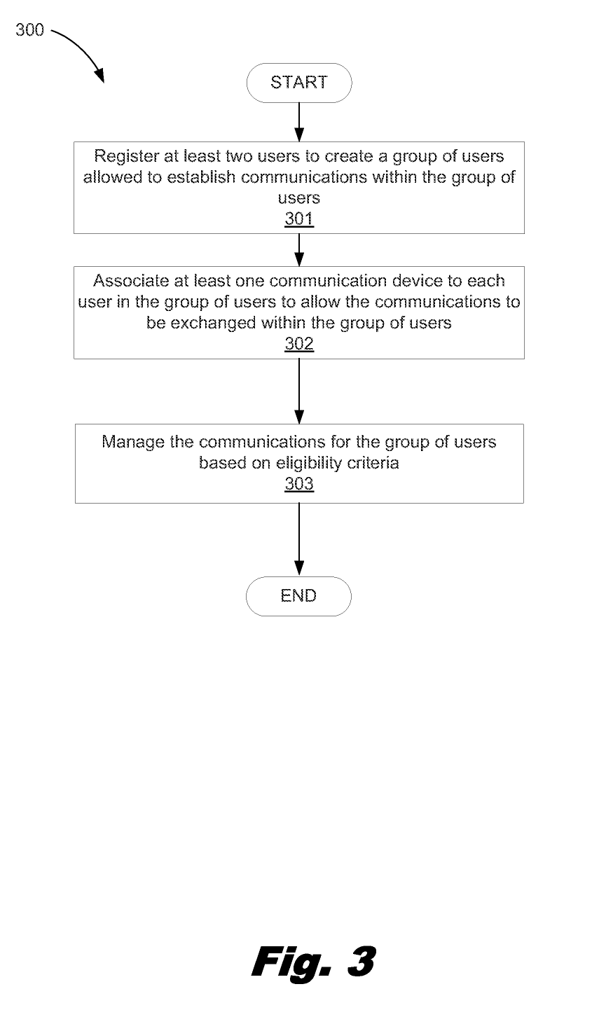

FIG. 3 is a flowchart of an example of a method for managing communications exchanged over communications channels according to one example of principles described herein. In one example, the method (300) may be executed by the managing system (200) of FIG. 2. In other examples, the method (300) may be executed by other system (i.e. system 500 and system 600). In this example, the method (300) includes with a managing system, registering (301) at least two users to create a group of users allowed to establish communications within the group of users, associating (302) at least one communication device to each user in the group of users to allow the communications to be exchanged within the group of users, and managing (303) the communications for the group of users based on eligibility criteria.

As mentioned above, the method (300) includes registering (301) at least two users to create a group of users allowed to establish communications within the group of users. In one example, registering at least two users to create a group of users allowed to establish communications within the group of users may include receiving user information from a user such as a name, an email address, a phone number, other information for combinations thereof.

For example, a family may use the managing system (200) of FIG. 2 to avoid distractions and disruptions on a family vacation. The father of the family may use communication devices such a mobile phone and a laptop. These communication devices are registered to the father by the managing system. This may be done by registering the father's mobile phone number, instant messaging user name, and email address. Further, a daughter may use a mobile phone. The mobile phone is registered to the daughter by the managing system as described above.

As mentioned above, the method (300) includes associating (302) at least one communication device to each user in the group of users to allow the communications to be exchanged within the group of user. For example, if a daughter registers a mobile phone via the managing system, the mobile phone is associated with the daughter. Further, if the father registers a mobile phone and a laptop, the mobile phone and the laptop are associated with the father.

As mentioned above, the method (300) includes managing (303) the communications for the group of users based on eligibility criteria. In one example, a managing engine manages communications for the group of users based on eligibility criteria. In this example, the managing engine includes an allowing engine to allow communications to be exchanged between the group of users. For example, if the father and the daughter desire to exchange communications, the allowing engine allows them to exchange communications.

The managing engine further includes a preventing engine to prevent communications from being exchanged between the group of users and a user not pertaining to the group of users. For example, if the father desires to exchange communications with a coworker, the preventing engine prevents the father from exchanging communication with the coworker.

As mentioned above, the preventing engine includes a redirecting engine. The redirecting engine redirects communications from being received by a user registered to the group of users from users not pertaining to the group of users. The redirecting engine prevents the communication from reaching the intended user in the group of users by diverting the communication to an alternate destination. In some examples, this destination may be a server, a module on a user's communication device, a forwarding email account or phone number, other destinations, or a combination thereof.

As mentioned above, the preventing engine includes a retaining engine. In one example, the retaining engine retains the communication sent by the user not pertaining to the group of users. In some examples, the retaining engine may block or delay the communication until a specific amount of time has passed since the communication was sent, until the user registers with the group of users, or combinations thereof.

As mentioned above, the managing engine includes a notifying engine. The notifying engine notifies at least one user not pertaining to the group of users that sent the communication that the intended a user in the group of users is unable to receive the communications.

As mentioned above, the managing system of FIG. 2 uses an eligibility criteria engine to further manage the communications for the group of users. In one example, the eligibility criteria engine includes a registration rules engine. The registration rules engine defines how at least one communication device is to be associated to each user in the group of users. For example, the registration rules engine may allow a user to specify that a communication device is to be associated to the user in the group of users for a specific amount of time. In another example, the registration rules engine may allow a user to specify that a communication device is to be associated to the user in the group of users based on proximity. For example, if the user is within a specific distance to other users in the group of users, the user's communication device is to be associated to the user in the group of users.

Further, the eligibility criteria engine includes a time range rules engine. The time range rules engine define a range of time for each user in the group of users to establish communications within the group of users. For example, the family may set a time range to allow all members of the family to register with the managing system to create a group of users while the family is on vacation. In other examples, the time range may be a specific amount of time, a time of day, such as “lunch”, meeting times, a recurring time slot, other time ranges, or combinations thereof.

Further, the eligibility criteria engine includes an analytical rules engine. The analytical rules engine defines at least one characteristic of a user that is allowed to register with the group of users, invited to register with the group of users, or combinations thereof. For example, a father of a family may set characteristics such as “coworkers” to “no” and “immediate family” to “yes”. As a result, the father may communicate with immediate family and prevent coworkers from communicating with him. In another example, the father may set an analytical rule characteristic to be “add to group based on location”. When users with communication devices that are location aware are in close proximity to the father, the managing system adds the communication devices to the father's group of users. Other analytical rules may include characteristics such as work groups, users working on the same work project, users on the same floor of a building, users in the same room of a building, users within a certain distance of each other, users in the same company, other analytical rules, or combinations thereof.

In some examples, a user in a group of users may attempt to defeat the purpose of a managing system. Examples of users attempting to defeat the purpose of the managing system may include, not registering all of their devices or communication device to exchange communications with entities outside of the group of users, registering with a group they are not welcome to register with, other methods, or combinations thereof. In such a situation, users of the group of users may enforce rules on the offending user. For example, if the father in the family neglects to register his email so that he can receive messages from work, the other members of the family group may obligate him to have his email registered to him or else he must leave the group of users.

In another example, the managing system is not set up to manage mobile devices. In this example, a user in the group of users is exchanging audio communications, during a meeting, via the user's mobile device. As mentioned above, the other users in the group of users may notify the managing system to manage mobile devices such that all mobile devices are prevented from exchanging communications. Alternatively, the users in the group of users may invite the user to leave the group of users if the user continues to use the mobile device.

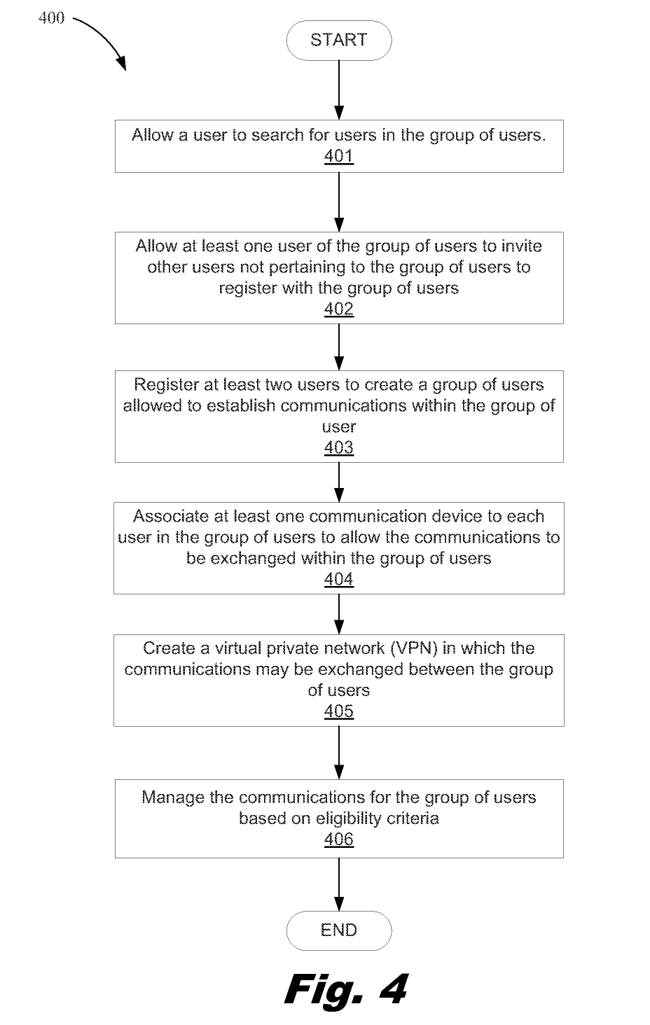

FIG. 4 is a flowchart of an example of a method for managing communications exchanged over communications channels according to one example of principles described herein. In one example, the method (400) may be executed by the managing system (200) of FIG. 2. In other examples, the method (400) may be executed by other system (i.e. system 500 and system 600). In this example, the method (400) includes with a managing system allowing (401) a user to search for users in the group of users, allowing (402) at least one user of the group of users to invite other users not pertaining to the group of users to register with the group of users, registering (403) at least two users to create a group of users allowed to establish communications within the group of user, associating (404) at least one communication device to each user in the group of users to allow the communications to be exchanged within the group of users, creating (405) a VPN in which the communications may be exchanged between the group of users, and managing (406) the communications for the group of users based on eligibility criteria.

As mentioned above, the method (400) includes allowing (401) a user to search for users in the group of users. In one example, a user interface is provide for an at least one user to search for an at least one other user. In this example, a user interface may include a graphical user interface, a voice recognition user interface, other user interfaces, or a combination thereof. The user interface allows a user to input a user's information that they are searching for. For example, an email address, a phone number, other information, or combinations thereof.

As mentioned above, the method (400) includes allowing (402) at least one user of the group of users to invite other users not pertaining to the group of users to register with the group of users. In some examples, the managing system provides a user interface for users to invite other users to register with a group of users. For example, the father may search for the daughter and when he finds her, he may add her or invite her to be added to the group of users.

As mentioned above, the method (400) includes creating (405) a VPN in which the communications may be exchanged between the group of users. In one example, creating VPN includes creating a private network hosted on a communication device of one of the users of the group of users, creating a private network on a local or remote server, or a combination thereof. The VPN is used to exchange communications between users in a group of users while remaining inaccessible to other users not pertaining to the group of users. For example, when the family mentioned above forms a group of users, a VPN may be created. The registered communication devices may exchange their communications through the VPN between members of the family. For example, members of the family may view each other's social media posts, but no one outside of the group of users may view the social media posts.

FIG. 5 is a diagram of an example of a managing system (500) according to the principles described herein. The managing system (500) includes a registering engine (502), an associating engine (504), and a managing engine (506). In this example, the managing system (500) also includes a searching engine (508), an inviting engine (510), and a creating engine (512). The engines (502, 504, 506, 508, 510, 512) refer to a combination of hardware and program instructions to perform a designated function. Each of the engines (502, 504, 506, 508, 510, 512) may include a processor and memory. The program instructions are stored in the memory and cause the processor to execute the designated function of the engine.

The registering engine (502) registers at least two users to create a group of users allowed to establish communications within the group of users. In some example, multiple groups of users may be created to allow a number of users to establish communications within the multiple groups of users.

The associating engine (504) associates at least one communication device to each user in the group of users to allow the communications to be exchanged within the group of users. In one example, the associating engine (504) associates multiple communication devices to each user in the group of users.

The managing engine (506) manages the communications for the group of users based on eligibility criteria. In one example, the managing engine (506) allows the communications to be exchanged between the group of users and prevents the communications from being exchanged between the group of users and a user not pertaining to the group of users. In one example, the eligibility criteria includes a registration rule, a time rule, an analytical rule, or combinations thereof.

The searching engine (508) allowing a user to search for users in the group of users. In one example, the search engine (508) allows a user to input a user's information that they are searching for. For example, an email address, a phone number, other information, or combinations thereof.

The inviting engine (510) allows at least one user of the group of users to invite other users not pertaining to the group of users to register with the group of users. In one example, the inviting engine (510) allows at least one user of the group of users to invite a user, a group of users, or combinations thereof.

The creating engine (512) creates a VPN in which the communications may be exchanged between the group of users. In one example, the creating engine (512) creates one VPN. In another example, the creating engine (512) creates multiple VPNs.

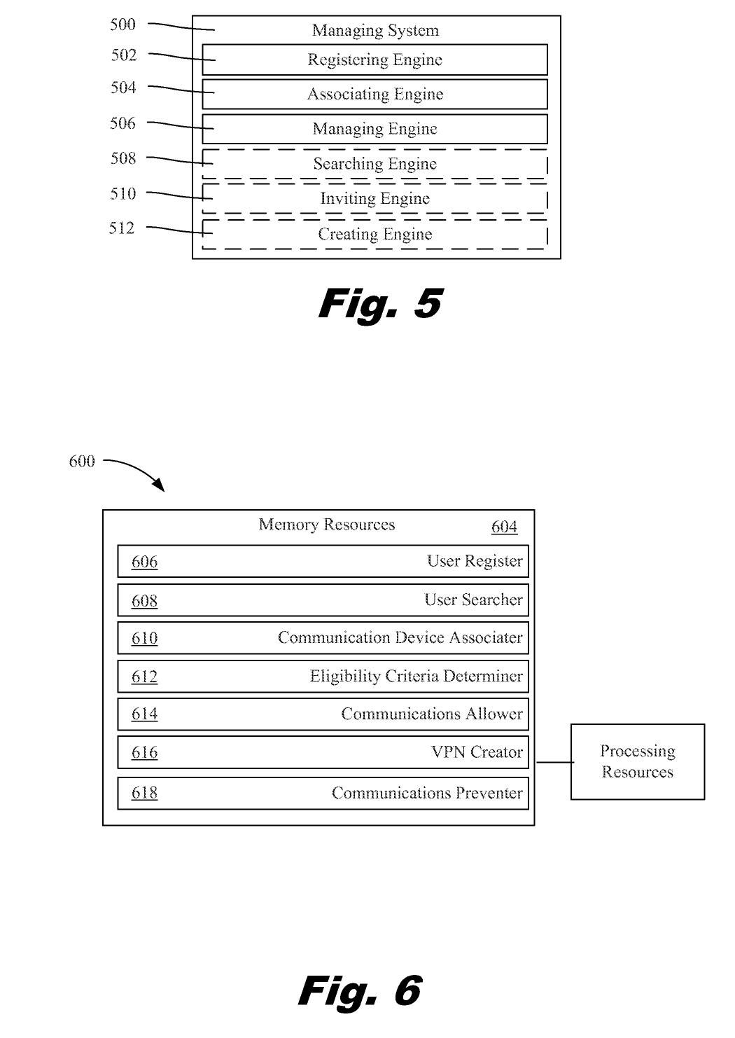

FIG. 6 is a diagram of an example of a managing system (600) according to the principles described herein. In this example, the managing system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the managing system (600). The programmed instructions shown stored in the memory resources (604) include a user register (606), user searcher (608), a communication device associater (610), an eligibility criteria determiner (612), a communications allower (614), a VPN creator (616), and a communications preventer (618).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The user register (606) represents programmed instructions that, when executed, cause the processing resources (602) to register at least two users to create a group of users allowed to establish communications within the group of users. The user searcher (608) represents programmed instructions that, when executed, cause the processing resources (602) to search for users in the group of users.

The communication device associater (610) represents programmed instructions that, when executed, cause the processing resources (602) to associate at least one communication device to each user in the group of users to allow the communications to be exchanged within the group of users. The eligibility criteria determiner (612) represents programmed instructions that, when executed, cause the processing resources (602) to determines eligibility criteria for managing the communications for the group of users.

The communications allower (614) represents programmed instructions that, when executed, cause the processing resources (602) to allow the communications to be exchanged between the group of users. The VPN creator (616) represents programmed instructions that, when executed, cause the processing resources (602) to create a VPN in which the communications may be exchanged between the group of users. The communications preventer (618) represents programmed instructions that, when executed, cause the processing resources (602) to prevent the communications from being exchanged between the group of users and a user not pertaining to the group of users.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (602) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the managing system (600) may be implemented on a user device, on a server, on a collection of servers, or combinations thereof.

The managing system (600) of FIG. 6 may be part of a general purpose computer. However, in alternative examples, the managing system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1-11. (canceled)

12. A system for managing communications for a group of users, the system comprising:
with a managing system:
a registering engine to register at least two users to create a group of users allowed to establish communications within the group of users;
an associating engine to associate at least one communication device to each user in the group of users to allow the communications to be exchanged within the group of users;
a searching engine to search for users in the group of users and users not pertaining to the group of users;
an inviting engine to invite other users not pertaining to the group of users to register with the group of users;
a creating engine to create a virtual private network (VPN) in which the communications may be exchanged between the group of users; and
a managing engine to manage the communications for the group of users based on eligibility criteria.

13. The system of claim 12, in which the managing engine comprises:
an allowing engine to allow the communications to be exchanged between the group of users; and
a preventing engine to prevent the communications from being exchanged between the group of users and a user not pertaining to the group of users.

14. The system of claim 13, in which the preventing engine comprises:
a redirecting engine to redirect the communications from the user not pertaining to the group of users to an alternate destination;
a retaining engine to retain the communications; and
a notifying engine to notify the user not pertaining to the group of users that a user pertaining to the group of users is unable to receive the communications.

15. The system of claim 12, in which the eligibility criteria determines if a user can register with the group of users, remain registered to the group of users, can be invited to register with the group of users, or combinations thereof.

16. The system of claim 15, in which the eligibility criteria comprises a registration rule, a time rule, an analytical rule, or combinations thereof.

17. The system of claim 16, in which
the registration rule defines how the at least one communication device is to be associated to the each user in the group of users;
the time rule defines a range of time for the each user in the group of users to establish communications within the group of user,
the analytical rule defines at least one characteristic of a user that is allowed to register with the group of users, invited to register with the group of users, or combinations thereof.

18. A computer program product for managing communications for a group of users, comprising:
a tangible computer readable storage medium, said tangible computer readable storage medium comprising computer readable program code embodied therewith, said computer readable program code comprising program instructions that, when executed, causes a processor to:
with a managing system:
register at least two users to create a group of users allowed to establish communications within the group of users; and
manage the communications for the group of users based on eligibility criteria.

19. The product of claim 18, further comprising computer readable program code comprising program instructions that, when executed, cause said processor to allow the communications to be exchanged between the group of users.

20. The product of claim 18, further comprising computer readable program code comprising program instructions that, when executed, cause said processor to prevent the communications from being exchanged between the group of users and a user not pertaining to the group of users.
